(19) United States
(12) Patent Application Publication
(10) Pub. No.: US 2005/0076130 A1
(43) Pub. Date: Apr. 7, 2005

(54) Targeted use of search results

(76) Inventors: Shubhasheesh Anand, Mountain View, CA (US); Victor Chang, Los Altos, CA (US)

Correspondence Address: VAN PELT & YI LLP, 10050 N. FOOTHILL BLVD #200, CUPERTINO, CA, 95014, US

(21) Appl. No.: 10/672,294

(22) Filed: Sep. 26, 2003

Related U.S. Application Data
(60) Provisional application No. 60/504,418, filed on Sep. 19, 2003.

(51) Int. Cl. G06F 15/16; G06F 17/30; G06F 7/00

(52) U.S. Cl. 709/228; 707/3

(57) ABSTRACT

A technique for presenting content is disclosed. The technique comprises saving a term used in a first application; associating the term with the content; and rendering the content in a presentation associated with a second presentation.

### FIELD OF THE INVENTION

The present invention relates generally to computer environments. More specifically, techniques for targeted presentations to a user are disclosed.

### BACKGROUND OF THE INVENTION

Online advertising is a substantial source of revenue over the Internet and other computer networks. Targeting end users (users) based on particular characteristics or behavior is a strong motivation for ensuring that advertisements and editorial content (content) are relevant to a particular user or group of users. Online advertisements and content may not be interesting to users, unless it is targeted to her particular interests. Conventional targeting methods include user profiles, behavioral, and content-themed integration. However, conventional targeting methods can generate low conversion rates (i.e., conversion of visitors to registered or paying users) or, often, drive a user away from a website if the advertisement is too obtrusive, intrusive, or interfering with her online activities.

Finding new opportunities to develop online advertising is difficult, particularly where users adapt and learn to ignore traditional placements. For example, if a user is a registered user of a news-oriented website, she may frequent the website at least once a day if not more. When visiting the news website, she reads articles and can distinguish editorial content from online advertisements. In so doing, she ignores traditional advertisements such as banner, flash, rich media, and other forms of ads. Online advertisements are often placed in areas where there is little or no targeting to the particular user. This type of placement results in low conversion or click through rates (CTR).

Thus, it would be useful to be able to better target users.

### BRIEF DESCRIPTION OF THE DRAWINGS

Various embodiments of the invention are disclosed in the following detailed description and the accompanying drawings.

FIG. 1A illustrates a system in accordance with an embodiment of the present invention;

FIG. 1B illustrates a system in accordance with an alternative embodiment of the present invention;

FIG. 2 illustrates a technique for targeted use of search results in accordance with an embodiment of the present invention;

FIG. 3 illustrates a technique for integrating search results and sponsored content in accordance with an embodiment of the present invention;

FIG. 4 illustrates a technique for integrating sponsored search results with a non-search application, in accordance with an embodiment of the present invention; and

FIG. 5 illustrates a technique for integrating sponsored content with a non-search application, in accordance with an embodiment of the present invention.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and invention may be practiced according to the claims without some or all of these specific details. For the purpose of clarity, technical material that is known in the technical fields related to the invention has not been described in detail so that the invention is not unnecessarily obscured.

Targeting improves the relevancy of a message, advertisement, etc. to a particular user or set of users. Presentation may also be improved by targeting based on a given user's online actions, which renders a message, advertisement, or content difficult to ignore. In one embodiment, understanding an individual user's interests and creating an online application that merges advertising with primary content on a viewed page is used to improve targeting. By identifying and recording online interests of users, it is possible to target the same users on other websites and pages. Targeting based on search and browsing actions and presentation on pages related to search and non-search applications such as a web-based e-mail application can be used to deliver more relevant content to a user.

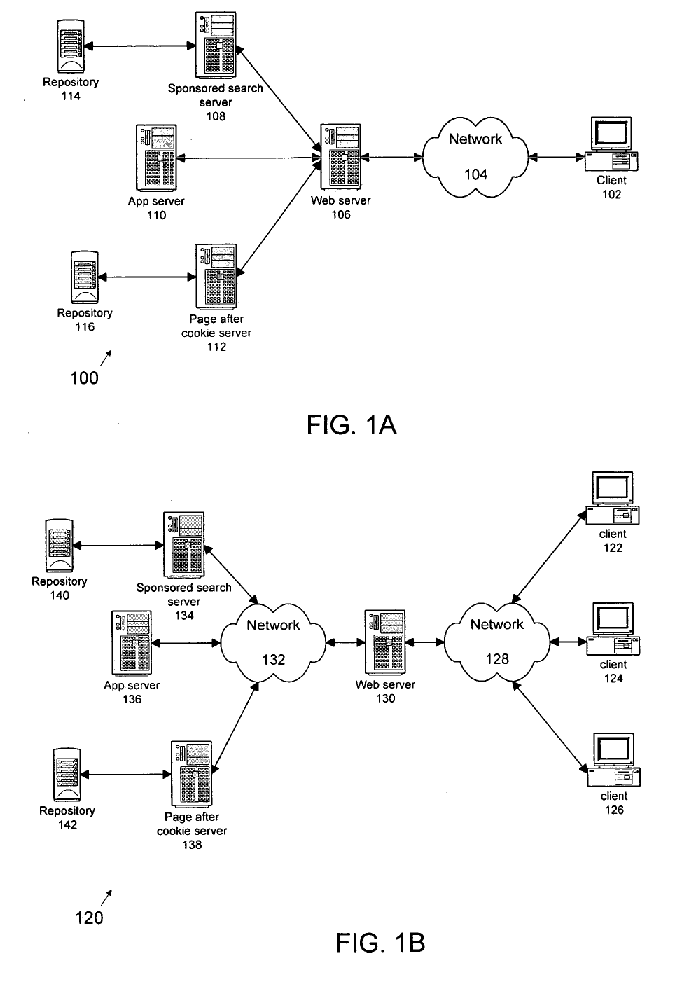

FIG. 1A illustrates a system 100 in accordance with an embodiment of the present invention. In this example, system 100 includes a client 102 communicating over network 104 with web server 106. Web server 106 can exchange data with sponsored search server 108, application server 110, or page after cookie server 112. Web server 106, sponsored search server 108, application server 110, and page after cookie server 112 can be implemented using a computer, server, client, or other computing device that provides processing, communication, and storage facilities. The system described is only one example of a system implementation and other embodiments may provide for fewer, greater, or different configurations or components.

In the example of FIG. 1, web server 106 provides data communication between client 102 and system 100. Web server 106 enables client 102 to send to and retrieve data from the Internet, web, or other network (e.g., LAN, WAN, etc.). Also in this example, application server 110 may be used to host and provide an operating environment for one or more applications. Included among these applications may be a search engine, web crawler, bot, or other search and non-search related applications. In other embodiments, application server 110 may also include or communicate with a repository to store and retrieve data from system 100.

Web server 106 may, at the user's request from client 102, retrieve data from sponsored search server 108, application server 110, page after cookie server 112, or any other server that can be used in the above example. Communicating with sponsored search server 108 is repository 114. Repository 116 may also be exchanging data with page after cookie server 112. Repositories 114 and 116 can be used to store data from other system 100 components. For example, page after cookie server 112 may store cookies, IDs, tokens, or other related information in repository 116. Sponsored search server 108 may store sponsored advertisements, sponsored search results, search terms related to sponsored searches, text, images, or other sponsored content in repository 114. Servers 106-112 may also be shown with other repositories, storage utilities, or memory components for storing data used by system 100.

FIG. 1B illustrates a system 120 in accordance with an alternative embodiment of the present invention. In alternative embodiments, the use of multiple clients and networks may be implemented using the techniques disclosed herein. For example, clients 122-126 communicate over network 128 to web server 130. In this example, web server 130 may be part of a distributed computing system using network 132 (e.g., LAN, WAN, WLAN, etc.). Web server 130 can exchange data over network 132 with sponsored search server 134, application server 136, and page after cookie server 138. Similar to FIG. 1A, sponsored search server 134 can store sponsored content in repository 140 such as that described above for FIG. 1A. Likewise, page after cookie server 138 can store cookies, profiles, IDs, and other identifying data in repository 142, similar to page after cookie server 112. Repositories 140 and 142 may be implemented using a database, SAN, NAS, disk array, RAID, or another type of storage.

The use of system 120 may be appropriate where a large distributed computing system is required with clients connecting over the Internet, for example. Not only are clients distributed, but system resources may also be spread across one or more networks, for example, where one or more system components are owned and operated by different entities or organizations. For example, one company may be operating and maintaining web server 130 whereas application server 136 may be owned by a content providing company. Continuing this example, an online advertising content company may be providing sponsored search server 134 and page after cookie server 138. In this example, each of the different companies are exchanging data over another network 132, apart from web server 130, which is being operated and maintained by an Internet Service Provider (ISP).

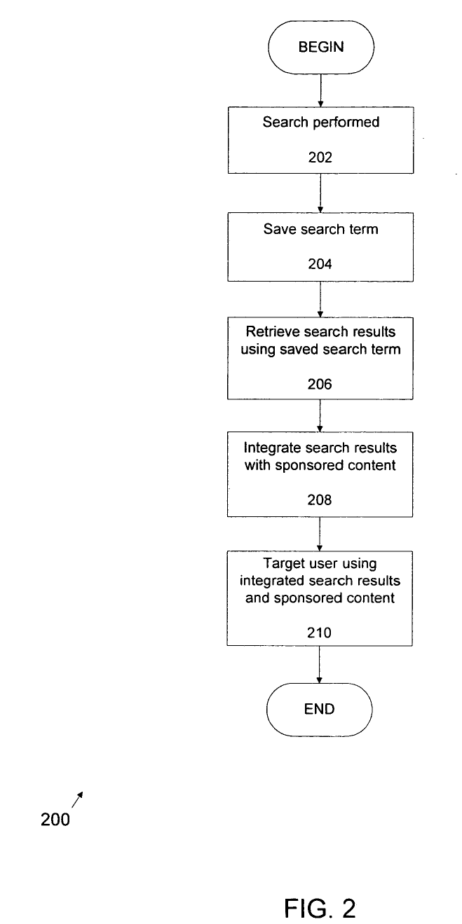

FIG. 2 illustrates a technique for targeted use of search results in accordance with an embodiment of the present invention. In this embodiment, search results may be used to target users who are using a search or non-search related application. First, a search is performed (202). The search term used in the search is then saved and can be later used as a key for retrieving content that can be used to target users (204). The key can be used in a later application to retrieve, map, or locate content such as sponsored content, messages, advertisements, etc. For example, if a user performs a web search for “autos,” the search term “autos” is saved and can be used as a key for targeting the user on other applications other than the initial web searching application in which the term was entered. In this embodiment, a user may exit the search application and begin using another application, such as e-mail or a web browsing application. The search term may be used to retrieve later search results (206). Once retrieved, the later search results can be integrated with sponsored content. In this example, search results that are generated from the web search can include content such as images, text, advertisements, or other material. On the other hand, sponsored content may also be similar in content, but may be placed, ranked, or prioritized above other material in return for a premium payment, rate, or sponsorship fee. In other embodiments, user behavior and actions can be analyzed to generate a more comprehensive set of sponsored content that is highly relevant to a particular user or set of users' interests.

Once retrieved, search results and sponsored content may be integrated (208). Integration of sponsored content and search results may also include integrated the combined result in the mode of the user or client, so that the integrated sponsored content and search results appears within the same design, motif, organization, or layout of the later application being used by the user (208). In this example, the later application is an application being used by a user after performing a search, from which the search term was saved. Sponsored content and search results are integrated so as to ensure that presentation of the integrated content and search results appears similar to the theme of the website that the user is currently viewing. Preferably, integrated content and search results should appear in the primary theme of the web page or website that the user is currently viewing. Using characteristics, behavior, or other user information may determine how sponsored content and search results should be integrated for a particular user or group of users. In so doing, the user is targeted using highly relevant content that may include messages, advertisements, or other forms of sponsored content (210).

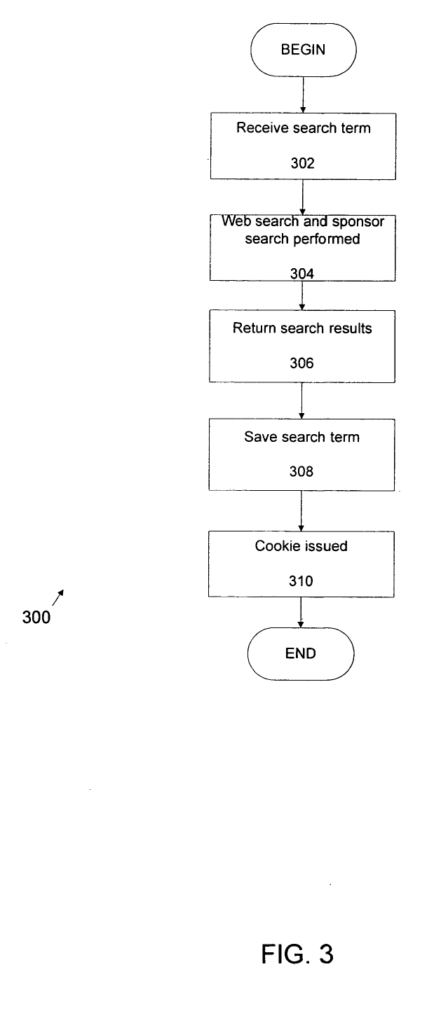

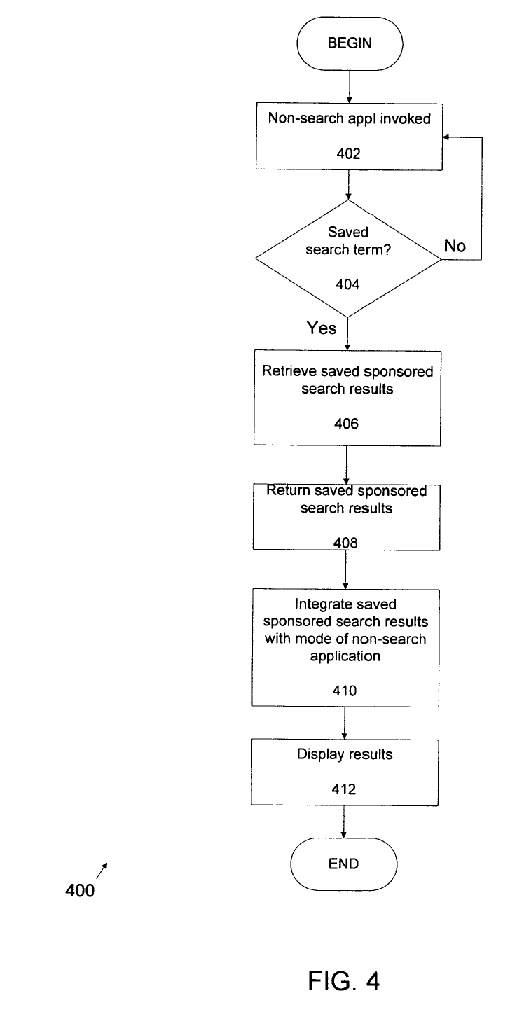

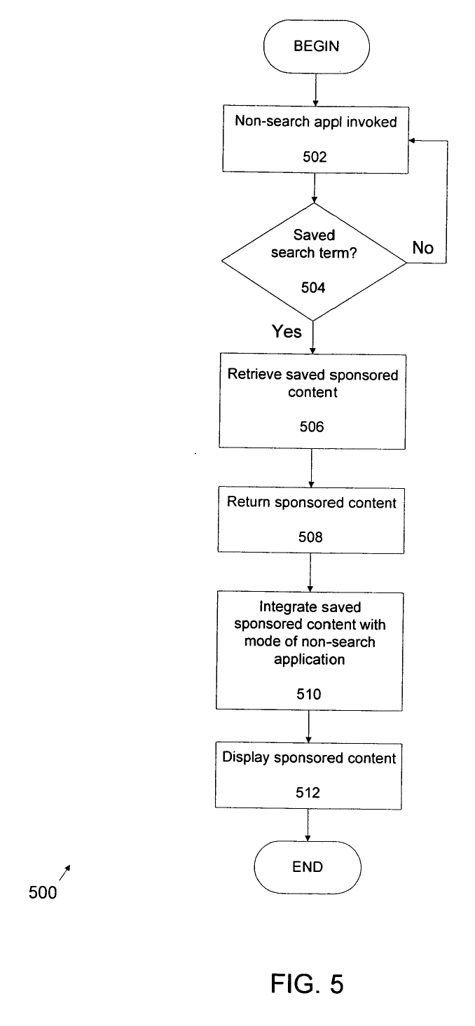

FIG. 3 illustrates a technique for integrating search results and sponsored content in accordance with an embodiment of the present invention. A search term is received, in this example, by a search engine or other search implement (302). A web search and a sponsored search may be performed (304). The web search locates information on the web or Internet and returns results. Sponsored search server 108 may also perform a search for sponsored content and return results as well. In some embodiments, by using a common search term, related web and sponsored searches return results that are relevant to each other (306). In other embodiments, associated terms can be used rather than the same term. After returning the search results to web server 106 or 108, the search term may be saved (308). Once saved, the search term may be retrieved for future use in other applications, which may or may not include search-related applications. The use of saved search terms is explained in further detail below with regard to FIGS. 4 and 5.

After a search term is saved, a cookie is optionally issued or updated (310). In this example, a cookie may be issued to identify a user and provide information to enable web server 106 to communicate with a web browser or browsing application on client 102 or clients 122-126. If a user discontinued a session, but later returns, a cookie can be used to identify the returning user and her profile as well as customize her web browser with information in the cookie. In other embodiments, other types of tokens may be used to identify a user. In still other embodiments, cookies and tokens may be used to identify a computer, client, server, or other implementation by which a user can interact with system 100 or 120.

FIG. 4 illustrates a technique for integrating sponsored search results with a non-search application, in accordance with an embodiment of the present invention. Non-search applications often provide concentrated areas of Internet traffic. For example, web-based e-mail applications that are generally not related to search engines or search technology are some of the most frequently used online applications. Search engines are also widely used by users seeking information on the web or Internet. By leveraging user-targeted elements of each type of application, a greater degree of relevancy can be achieved.

In the technique shown, a non-search application may be invoked, such as logging into a personal e-mail account or typing in the URL of a content website (402). For purposes of illustration, a non-search application may include e-mail, instant messaging, web-based e-mail, editorial, news, special interest, or other forms of content not related to search technology such as a search engine or web crawler.

It is then determined whether search terms were saved from a prior session (404). Web server 106 or 130 or other servers can be used to implement logic for analyzing and determining web sessions. In this example, a cookie or other token can be used to determine if search terms were saved from a prior session with the current user. If search terms were saved, then the saved terms are used to retrieve sponsored search results (406). Once retrieved, sponsored search results are returned to web server 106 or 130 (408). The returned sponsored search results are integrated with the mode of the non-search application (410). For example, if a user has invoked a web-based application for e-mail (e.g., Yahoo! Mail, Earthlink Webmail, MSN Hotmail, etc.), then sponsored search results can be integrated and then displayed within the current user interface with a presentation such that the user is less likely to ignore the sponsor matches (412). This can be achieved by user interface design that uses similar presentation techniques for sponsored matches as for regular content on that page. In this example, recorded user behavior such as saved search terms may be used to target users. In other examples, user activity, characteristics, or other representations of user interest may be used to determine the sponsored search results that should be returned for integration, targeting and display to the user.

Integration of sponsored content with a non-search application may be implemented in a variety of forms. For example, in an e-mail application, using sponsored search results saved from a previous user session could be integrated as transient messages or messages set apart from the standard set of personally-addressed messages that a user may find in her e-mail inbox, sponsored matches that appear as e-mail messages in an e-mail application is another example. Yet another example may include placing sponsored content saved from a previous search session as banner advertisements or positioned in the left or right navigation bars of a user interface, but integrated with the theme of the current website. For example, if search results are generated, but the user leaves the search website to view a news article on another website, then the sponsored content (e.g., sponsored advertisements, sponsored search results, etc.) may be integrated with the news website. The sponsored content may be rendered using the same font, character type, text, colors, styles, or other layout characteristics as the news website. The integration of the sponsored content with the theme of the news website may increase the likelihood that the user acts on an offer or ad in the sponsored content. Other examples of integration may be implemented and are not limited to those described above.

FIG. 5 illustrates a technique for integrating sponsored content with a non-search application, in accordance with an embodiment of the present invention. In this example, a non-search application may be invoked (502). It is then determined whether search terms have been saved (504). If search terms have not been saved, then web server 106 or 130 returns the requested page without any sponsored content. If search terms had been saved, then they are retrieved, and matched with content from sponsored search server 108 or 134 (506). Sponsored content is then returned to the requesting computer, such as web server 106 or 130 (508).

In this example, returned sponsored content may be integrated within the mode of the non-search application. In other embodiments, returned sponsored content may remain non-integrated. In this example, returned sponsored content can be integrated with the theme of the non-search application invoked earlier (510). Once integrated, the sponsored content can be presented (512). Presentation of the sponsored content may appear to be thematically-integrated with a particular graphical user interface. For example, sponsored content displayed in a news application may be presented in an unobtrusive manner apart from a news articles but in a format that resembles the format of a news article. The sponsored content derived from a previous user's search may be more likely to instill a user's purchase or other action based on the sponsored content because the user has shown an interest in that content in the past. Further, the integration of sponsored content creates a greater likelihood that CTRs as well as paid or registered user levels increase due to the improved relevancy. Unlike conventional sponsored search implementations, techniques disclosed herein provide greater relevancy and user targeting because sponsored content is derived from a comprehensive analysis of user behavior, specifically, previous searches. In some embodiments, by using sponsored content, such as sponsored search results and integrating these results with information presented to the same user but in a different application, relevancy can be significantly increased. Arranged in an integrated and relevant manner, sponsored content (e.g., sponsored search results, sponsored advertisements, etc.) create a greater probability that a particular user may act on a message or offer contained in the sponsored content. In some embodiments, sponsored content could be displayed in a non-integrated manner. In this example, recorded user behavior such as saved search terms may be used to target users. In other examples, user activity, characteristics, or other representations of user interest may be used to determine the sponsored search results that should be returned for integration, targeting and display to the user.

Although the foregoing embodiments have been described in some detail for purposes of clarity of understanding, the invention is not limited to the details provided. There are many alternative ways of implementing the invention. The disclosed embodiments are illustrative and not restrictive.

1. A method for presenting content comprising:
recording a user behavior used in a first application;
associating the user behavior with content and a second application; and
targeting a user with the associated user behavior and content in a presentation associated with the second application.

2. A method for presenting content as recited in claim 1 wherein recording a user behavior used in a first application includes saving a search term.

3. A method for presenting content as recited in claim 1 wherein recording a user behavior used in a first application includes recording an action.

4. A method for presenting content as recited in claim 1 wherein recording a user behavior used in a first application includes recording a characteristic.

5. A method for presenting content as recited in claim 1 wherein recording a user behavior used in a first application includes recording a user interest.

6. A method for presenting content as recited in claim 1 wherein recording a user behavior used in a first application includes saving a result.

7. A method for presenting content as recited in claim 1 wherein associating the user behavior with the content further includes integrating the content with a result.

8. A method for presenting content as recited in claim 1 wherein associating the user behavior with the content further includes integrating the content with the second application.

9. A method for presenting content as recited in claim 1 wherein targeting a user with the associated user behavior and content in a presentation associated with the second application further includes displaying the content integrated with the second application.

10. A method for presenting content as recited in claim 1 wherein targeting a user with the associated user behavior and content in a presentation associated with the second application further includes displaying the content as a transient message integrated with the second application.

11. A method for presenting content as recited in claim 1 wherein targeting a user with the associated user behavior and content in a presentation associated with the second application further includes displaying the content integrated with a theme of the second application.

12. A method for presenting sponsored content comprising:
saving a term used in a first application to produce a key;
mapping the key to the sponsored content;
integrating the mapped key and sponsored content with a second application; and
rendering the integrated mapped key and sponsored content in a second application.

13. A method for presenting a sponsored content, comprising:
saving a term used in a first application to produce a sponsored search result;
returning the sponsored search result to the first application;
integrating the sponsored search result with content in a second application; and
rendering the integrated sponsored search result with content in the second application.

14. A system for presenting content comprising:
a memory configured to record a user behavior used in a first application;
a processor configured to associate the user behavior with content and a second application; and
a presentation configured to target a user with the associated user behavior and content in a presentation associated with the second application.

15. A data signal embodied in a carrier wave comprising:
instructions for recording a user behavior used in a first application;
instructions for associating the user behavior with content and a second application; and
instructions for targeting a user with the associated user behavior and content in a presentation associated with the second application.

16. A computer program product for presenting content, the computer program product being embodied in a computer readable medium and comprising computer instructions for:
recording a user behavior used in a first application;
associating the user behavior with content and a second application; and
targeting a user with the associated user behavior and content in a presentation associated with the second application.
